(19) United States
(12) Patent Application Publication
(10) Pub. No.: US 2020/0142653 A1
(43) Pub. Date: May 7, 2020

(54) INFORMATION PROCESSING APPARATUS AND METHOD FOR CONTROLLING THE SAME

(71) Applicant: KYOCERA Document Solutions Inc., Osaka (JP)

(72) Inventor: Patricia Ysabel GARCES, Osaka (JP)

(73) Assignee: KYOCERA Document Solutions Inc., Osaka (JP)

(21) Appl. No.: 16/586,450

(22) Filed: Sep. 27, 2019

(30) Foreign Application Priority Data
Nov. 7, 2018 (JP) 2018-209716

(51) Int. Cl. G06F 3/12

(52) U.S. Cl. CPC G06F 3/1248; G06F 3/1254; G06F 3/1298; G06F 3/1256; G06F 3/1208

(57) ABSTRACT

When an input device accepts specification of a storage destination, a processor in an information processing apparatus analyzes a printing description file stored at the storage destination. The processor makes a display display the number of sheets required for printing the printing description file. The printing description file contains data temporarily stored at the storage destination before it is transmitted to an image forming apparatus. The printing description file contains data which is generated by converting a file and which describes printing content using a command.

INCORPORATION BY REFERENCE

This application is based upon and claims the benefit of priority from the corresponding Japanese Patent Application No. 2018-209716 filed on Nov. 7, 2018, the entire contents of which are incorporated herein by reference.

### BACKGROUND

The present disclosure relates to an information processing apparatus which converts a file to generate printing data.

During printing, a file may be converted into printing data written in a page description language. The converted data may be transmitted to an image forming apparatus. The image forming apparatus performs printing based on the data written in the page description language. At present, different page description languages are used. There are known techniques, such as the one discussed below, by which printing is performed corresponding to a plurality of page description languages.

There is a known printing system that distributes documents among a plurality of printers, the system including a spooler which generates a printing job for each document, a page description language guesser which includes a plurality of page description language analyzing units analyzing data samples of character sets to sample a data sample including command operator symbol strings of a page description language of a document in order to determine the encoding method of the page description language, and a supervisor which transmits a printing job of a document from the spooler to one of the printers which can print the page description language of the printing job of the document. This configuration is aimed at efficient analysis of PDLs during a series of printing jobs.

Printing data written in a page description language may be pooled temporarily. For example, printing data is pooled in a prescribed folder. The pooled printing data may be transmitted to an image forming apparatus at once. When a large number of sets of printing data are pooled, a user needs to check the content manually for each set of printing data.

### SUMMARY

According to one aspect of the present disclosure, an information processing apparatus includes a display, an input device, and a processor. The display performs displaying. The input device accepts input operation. When the input device accepts specification of a storage destination, the processor analyzes a printing description file stored at the storage destination. The processor makes the display display the number of sheets required for printing the printing description file. The printing description file contains data stored temporarily at the storage destination before being transmitted to an image forming apparatus. The printing description file is used in printing by the image forming apparatus. The printing description file contains data which is generated by converting a file and which describes printing content using commands.

According to another aspect of the present disclosure, a method of controlling an information processing apparatus includes: upon accepting specification of a storage destination, analyzing a printing description file stored at the storage destination; displaying the number of sheets required for printing the printing description file based on analysis results; the printing description file containing data stored temporarily at the storage destination before being transmitted to an image forming apparatus; using the printing description file in printing by the image forming apparatus, and the printing description file containing data which is generated by converting a file and which describes printing content using commands.

This and other characteristics of the present disclosure, and the specific benefits obtained according to the present disclosure, will become apparent from the description of embodiments which follows.

### BRIEF DESCRIPTION OF THE DRAWINGS

FIG. 1 is a diagram showing one example of an image forming system according to an embodiment;

FIG. 2 is a diagram showing one example of an information processing apparatus according to the embodiment;

FIG. 3 is a diagram showing one example of processing by the information processing apparatus according to the embodiment;

FIG. 4 is a diagram showing one example of an image forming apparatus according to the embodiment;

FIG. 5 is a diagram showing one example of a setting screen according to the embodiment;

FIG. 6 is a diagram showing one example of analysis processing by the information processing apparatus according to the embodiment;

FIG. 7 is a diagram showing one example of a procedure of analysis processing according to the embodiment;

FIG. 8 is a diagram showing one example of a procedure of analysis processing according to the embodiment;

FIG. 9 is a diagram showing one example of a procedure of analysis processing according to the embodiment;

FIG. 10 is a diagram showing one example of an analysis result screen according to the embodiment; and

FIG. 11 is a diagram showing one example of the setting screen according to the embodiment;

### DETAILED DESCRIPTION

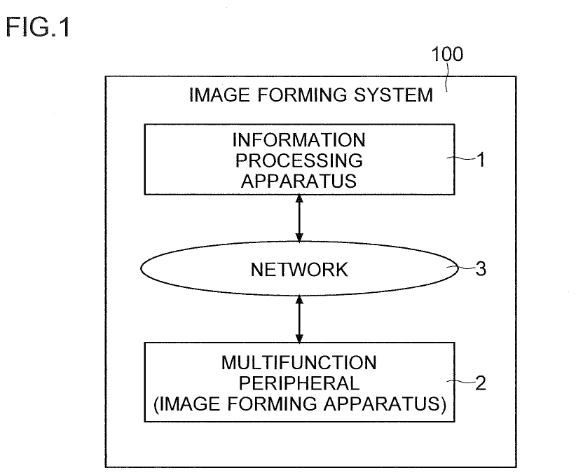

The object of the present disclosure is to make it possible to easily confirm the number of sheets required for printing a temporarily stored file written in a page description language. Hereinafter, with reference to FIGS. 1 to 11, an information processing apparatus 1 and an image forming system 100 according to an embodiment of the present disclosure will be described. All the features, in terms of structure, arrangement, and the like, described in connection with the embodiment are merely examples for the sake of description, and are in no way meant to limit the scope of the disclosure.

### Image Forming System 100

With reference to FIG. 1, one example of the image forming system 100 according to the embodiment will be described. As shown in FIG. 1, the image forming system 100 includes the information processing apparatus 1 and an image forming apparatus 2. There may be a plurality of information processing apparatuses 1 and a plurality of image forming apparatuses 2. For the sake of convenience, one for each of the apparatuses is shown in FIG. 1. The information processing apparatus 1 and the image forming apparatus 2 can communicate with each other via a network 3.

The information processing apparatus 1 is a computer. The information processing apparatus 1 is, for example, a PC. The information processing apparatus 1 may be a mobile communication device such as a smartphone. The information processing apparatus 1 can transmit a printing description file F1 to the image forming apparatus 2. Based on the printing description file F1 from the information processing apparatus 1, the image forming apparatus 2 prints.

### Information Processing Apparatus 1

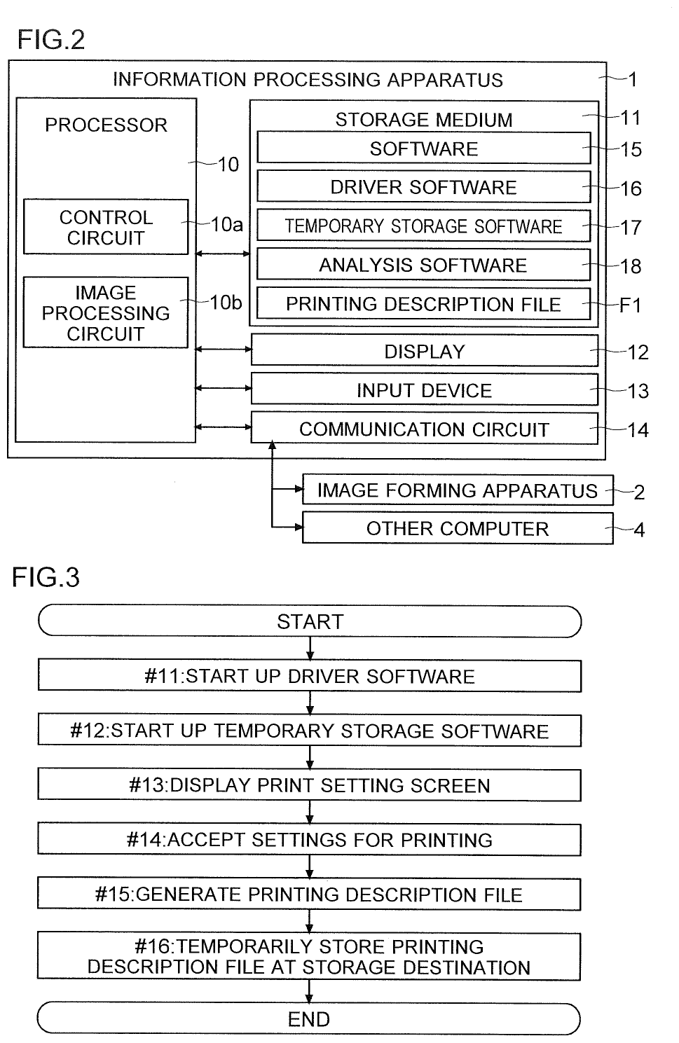

Next, with reference to FIGS. 2 and 3, an example of the information processing apparatus 1 according to the embodiment will be described. The information processing apparatus 1 includes a processor 10, a storage medium 11, a display 12, an input device 13, and a communication circuit 14.

The processor 10 is an electronic circuit board including a plurality of circuits and elements. The processor 10 is a circuit board (control circuit board) including, for example, a control circuit 10a (CPU) and an image processing circuit 10b. The storage medium 11 stores an OS, data, and different programs in a non-volatile manner. As the storage medium 11, the information processing apparatus 1 includes a flash ROM, a HDD, and a RAM. The processor 10, based on the OS, data, and different programs, controls operation of the information processing apparatus 1. The processor 10, according to the content stored on the storage medium 11, controls different portions of the information processing apparatus 1.

The processor 10 makes a display 12 display screens and information. The display 12 includes, for example, a liquid crystal panel or an organic EL panel. The input device 13 accepts user operation. The input device 13 is, for example, a keyboard or a mouse. The input device 13 may be a touch panel. Based on the output of the input device 13, the processor 10 recognizes the content of operation.

The communication circuit 14 includes a communication control circuit and a communication memory. The communication memory stores communication software. The communication circuit 14 communicates with the image forming apparatus 2 according to an instruction from the processor 10. The communication circuit 14 can communicate with devices other than the image forming apparatus 2. The communication circuit 14 can communicate with, for example, another computer 4.

On the storage medium 11 in the information processing apparatus 1, software 15, driver software 16, and temporary storage software 17 are installed. With reference to FIG. 3, the flow of processing using the driver software 16 and the temporary storage software 17 will be described.

For example, software 15 such as word-processing software, spreadsheet software, image data editing software, and OCR software are installed on the storage medium 11. A user starts up the software 15. Using the input device 13, the user can create, edit, and save data (a file) of the started software 15. The user can, for example, create, edit, and save a document file using word-processing software.

The input device 13 accepts a command to print a file. The print command is an instruction to print the content of each page of the file. “Start” in FIG. 3 is the time point at which the input device 13 accepts a print command.

When the input device 13 accepts a print command, the processor 10 starts up the driver software 16 (step #11). Together, the processor 10 also starts up the temporary storage software 17 (step #12). The temporary storage software 17 is software for temporarily storing the generated printing description file F1 (and print setting information) at a predetermined storage destination.

Based on the driver software 16, the print setting screen is displayed on the display 12 (step #13). The user can make settings related to printing using the input device 13. The input device 13 accepts settings for printing (step #14). It is possible to set, for example, the number of print copies 64, which of duplex or simplex printing is performed, and the sheet size used for the printing.

When the input device 13 accepts completion of setting on the print setting screen, based on the driver software 16, the processor 10 generates the printing description file F1 (step #15). The processor 10 converts the file for which the print command (print instruction) was entered to generate the printing description file F1. The processor 10 generates, for example, data in which the content of each page and the settings are described in the page description language as the printing description file F1. For the page description language, for example, PRESCRIBE, PostScript, or PCL can be used. PRESCRIBE is a page description language developed by the applicant. The page description languages which can be used are not limited to the ones mentioned above.

In a PDF file, the content of a page is written in commands (codes). In the PDF file, the content of the page is written in conformity with a predetermined grammar and syntax. The PDF file is one kind of the printing description file F1. When the input device 13 accepts the print command for a PDF file, the processor 10 uses the PDF file as it is as the printing description file F1. The processor 10 does not convert the PDF file (does not rewrite it in the page description language). The processor 10 may rewrite the PDF file in the page description language.

The processor 10 attaches to (includes in) the generated printing description file F1 the print setting information. The print setting information is, for example, PJL data. The print setting information is information for transmitting settings related to printing to the image forming apparatus 2. The processor 10 includes a file name 53 of the file converted into the printing description file F1, the language used in the printing description file F1, the settings that have been input, and the like in the print setting information.

Next, based on the temporary storage software 17, the processor 10 temporarily stores the generated printing description file F1 (and printing setting information) at the predetermine destination (step #16). Until transmission to the image forming apparatus 2 is completed, the processor 10 retains the printing description file F1 and the print setting information at the storage destination. The processor 10 ends the flow chart (END).

The storage destination can be set in a non-volatile storage area on the storage medium 11 (see FIG. 2). For example, a part of the storage area in the HDD in the information processing apparatus 1 can be allocated as the storage destination. The input device 13 accepts the setting of the storage destination. Based on the temporary storage software 17, the processor 10 makes the printing description file F1 stored at the set storage destination.

It is also possible to set an area shared with the other computer 4 as the storage destination. The other computer 4 is a computer which is communicable with the information processing apparatus 1. The other computer 4 is, for example, a PC or a server. In this case, the temporary storage software 17 may be installed also on the other computer 4. When the other computer 4 generates the printing description file F1, the other computer 4 makes the generated printing description file F1 stored at the storage destination.

The input device 13 accepts a command to transmit the printing description file F1 stored at the storage destination 2 to the image forming apparatus. When the input device 13 accepts the transmission command, the processor 10 makes the communication circuit 14 transmit the printing description file F1 present at the storage destination toward the image forming apparatus 2. The processor 10 transmits the printing description file F1 (print setting information). For example, transmission based on the FTP protocol is performed. With the FTP protocol, even with a large amount of data, printing description file F1 can be transmitted at high speed. Upon receiving the printing description file F1, the image forming apparatus 2 performs printing based on the printing description file F1. The processor 10 deletes the transmitted printing description file F1 and the print setting information from the storage destination (the end of the temporary storage).

In the storage medium 11 in the information processing apparatus 1, analysis software 18 is installed. The analysis software 18 is software for analyzing the printing description file F1 stored at the storage destination. The analysis software 18 is software for displaying the analysis results on the display 12. Based on the analysis software 18, the processor 10 performs analysis and display (which will be described in detail later).

### Image Forming Apparatus 2

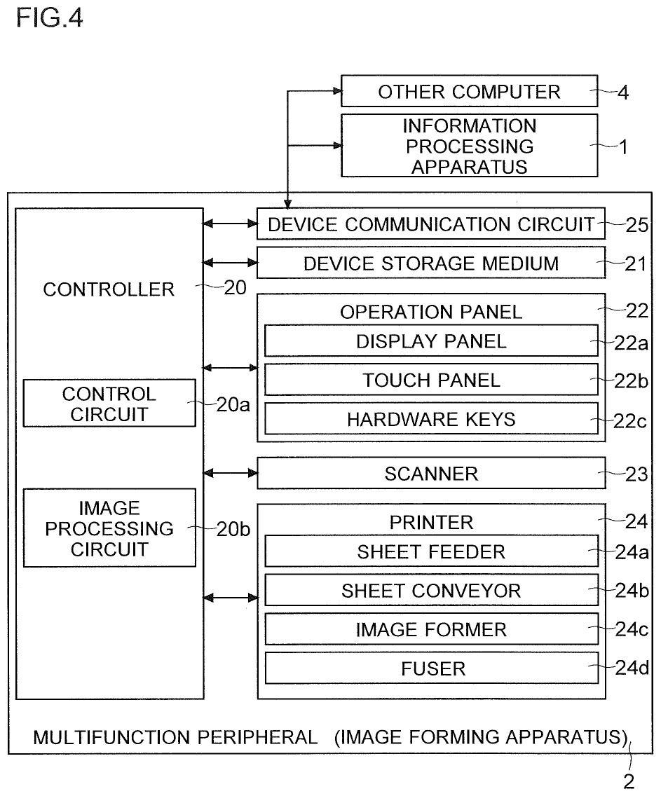

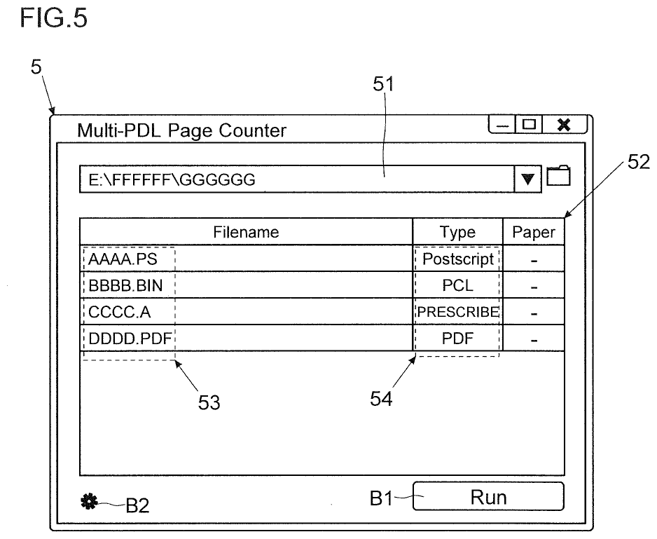

Next, with reference to FIG. 4, one example of the image forming apparatus 2 according to the embodiment will be described. As shown in FIG. 4, the image forming apparatus 2 includes a controller 20 and a device storage medium 21. The controller 20 controls different parts of the image forming apparatus 2. The controller 20 includes a control circuit 20a and an image processing circuit 20b. The control circuit 20a is, for example, a CPU. The control circuit 20a performs calculation and processing related to control. The image processing circuit 20b performs processing of image data. The image forming apparatus 2 includes a storage device such as a ROM, a RAM, and a HDD as the device storage medium 21. The device storage medium 21 stores control programs and various kinds of data.

The image forming apparatus 2 includes an operation panel 22. The operation panel 22 includes a display panel 22a, a touch panel 22b, and hardware keys 22c. The controller 20 controls display on a display panel 22a. The controller 20 makes screens and images displayed on the display panel 22a. In addition, based on an output from the touch panel 22b and the hardware keys 22c, the controller 20 recognizes what is set by a user.

The image forming apparatus 2 includes a scanner 23. The scanner 23 reads a document that is set. The scanner 23 generates image data of the document. The image data of the document is stored, for example, on the storage medium 11.

The image forming apparatus 2 includes a printer 24. The printer 24 includes a sheet feeder 24a, a sheet conveyor 24b, an image former 24c, and a fuser 24d. The sheet feeder 24a includes, for example, a sheet feeding roller and a sheet feeding motor. The sheet conveyor 24b includes a conveying roller pair and a conveying motor. During a printing job, the controller 20 makes the sheet feeder 24a feed sheets one after another. The controller 20 makes the sheet conveyor 24b convey a sheet.

The image former 24c includes, for example, a photosensitive drum, a charging device, a developing device, and a transfer roller. The controller 20 makes the image former 24c form a toner image using toner. The controller 20 makes the image former 24c form a toner image based on print image data. A transfer roller transfers the toner image on the photosensitive drum onto a sheet. The controller 20 makes a fuser 24d fix the toner image. The fuser 24d includes a heater and a fixing rotary member. The fixing rotary member applies heat and pressure to the transferred sheet. The controller 20 makes the sheet conveyor 24b discharge the fixed (printed) sheet out of the apparatus (onto a discharge tray).

The printer 24 supports duplex printing. When duplex printing is performed, the controller 20 makes the sheet conveyor 24b reverse the obverse and reverse sides of a sheet printed on one side. The sheet conveyor 24b includes a switch-back mechanism by which the obverse and reverse sides of a sheet are reversed. The switch-back mechanism includes a switch back roller pair. The controller 20 rotates the switch-back roller pair to reverse the obverse and reverse sides of a sheet printed on one side. The controller 20 makes the sheet conveyor 24b convey the reversed sheet back to the upstream side of the image former 24c. The sheet conveyor 24b includes a conveying passage for conveying the sheet that has passed through the fuser 24d back to the image former 24c and a conveying member (roller).

The image processing circuit 20b analyses the received printing description file F1. Then, based on the printing description file F1, the image processing circuit 20b generates image data (raster data). The controller 20 makes the printer 24 perform printing based on generated image data.

The image forming apparatus 2 includes a device communication circuit 25. The device communication circuit 25 includes a connector for communication, a communication control circuit, and a communication memory. The device communication circuit 25 communicates with the information processing apparatus 1 or the other computer 4 via the network 3.

### Settings for Analysis

Next, with reference to FIG. 5, an example of settings for analysis in the information processing apparatus 1 according to the embodiment will be described. The input device 13 accepts an instruction to start up the analysis software 18. When a start-up instruction is entered, the processor 10 reads the analysis software 18 to start it up. The processor 10 makes a setting screen 5 for the analysis software 18 displayed on the display 12. FIG. 5 shows one example of the setting screen 5 displayed during start-up of the analysis software 18. The user makes settings on the setting screen 5.

On the setting screen 5, there are provided a storage destination specification field 51, a file list 52, and a Run button B1 (execution button). The user operates the storage destination specification field 51 to specify the storage destination (storage location) at which the printing description file is temporarily stored. The storage destination provided on the storage medium 11 can be specified. Instead, specifying of a storage area shared with the other computer 4 or another server may be allowed. The input device 13 accepts the specification of the storage destination.

The file list 52 is a list of the printing description files F1 stored at a specified storage destination. In the file list 52, one printing description file F1 is allocated to each line. The file name 53 of the printing description file F1 and its type 54 are displayed in one line.

The processor 10 recognizes the type 54 of the printing description file F1 stored at the specified storage destination. In other words, the processor 10 recognizes the description format of the printing description file F1 and the page description language used there. For example, the processor 10 recognizes the type 54 of the printing description file F1 based on the identifier of the printing description file F1. The used page description language may be written in the print setting information attached to the printing description file F1. The processor 10 may check the print setting information to recognize the type 54 of the printing description file F1. The processor 10 recognizes the used page description language. The processor 10 may search the printing description file F1 for a description indicating the language and the type 54. The processor 10 makes the display 12 display the type 54 of the recognized printing description file F1.

When the specified storage destination is another computer 4 or a server, the processor 10 may acquire the printing description file F1 itself from the specified storage destination. Then, the processor 10 recognizes the type 54 of the acquired printing description file F1. FIG. 5 shows an example where four printing description files F1 are temporarily stored at a specified storage destination. In the example in FIG. 5, four printing description files F1 include a Postscript file, a PCL file, a PRESCRIBE file, and a PDF file.

When a user wants to check the number of sheets required for printing the printing description file F1, the user operates the Run button B1. The input device 13 accepts operation on the Run button B1.

### Analysis of the Printing Description File F1

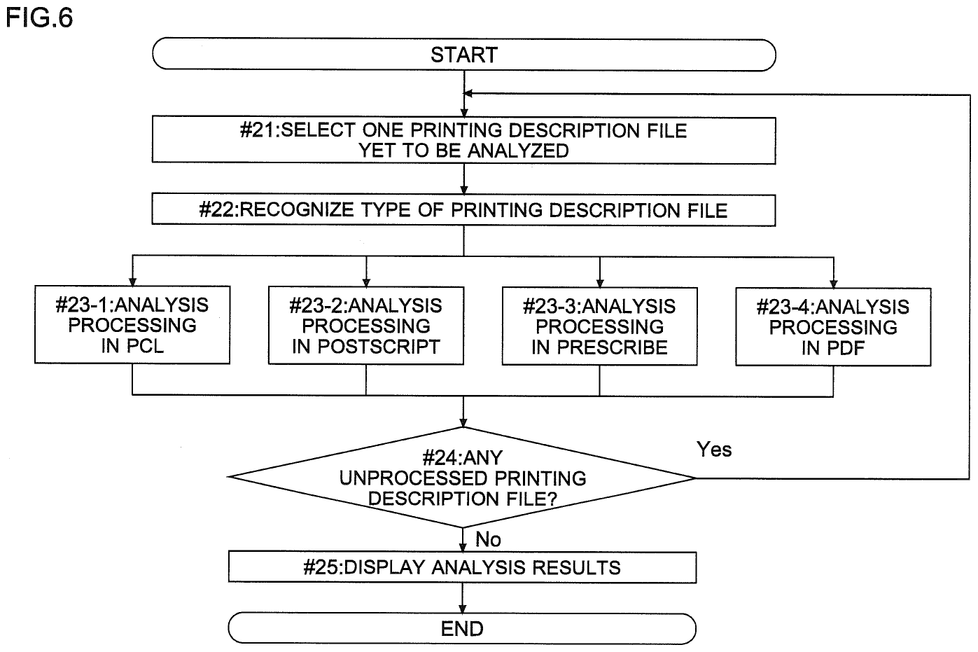

Next, with reference to FIGS. 6 and 11, an example of analysis of the information processing apparatus 1 according to the embodiment will be described. FIG. 6 shows one example of a basic flow of analysis of the printing description file F1. “START” in FIG. 6 is the time point at which the Run button B1 is operated (pressed). The processor 10 selects one printing description file F1 yet to be analyzed which is stored at the storage destination (step #21). Next, the processor 10 recognizes the type 54 (format, page description language) of the selected printing description file F1 (step #22).

The processor 10, according to the recognized type 54, analyzes the printing description file F1 (step #23-1 to step #23-4). In other words, the processor 10 recognizes the content and commands described in the printing description file F1.

When the type 54 of the printing description file F1 is PCL, the processor 10 analyzes the printing description file F1 in PCL (step #23-1). When the type 54 of the printing description file F1 is Postscript, the processor 10 analyzes the printing description file F1 in Postscript (step #23-2). When the type 54 of the printing description file F1 is PRESCRIBE, the processor 10 analyzes the printing description file F1 in PRESCRIBE (step #23-3). When the type 54 of the printing description file F1 is PDF, the processor 10 analyzes the printing description file F1 in PDF (step #23-4).

After the printing description file F1 is analyzed, the processor 10 checks whether there is any unprocessed printing description file F1 (step #24). In other words, the processor 10 checks whether all the printing description files F1 stored at the storage destination have been analyzed or not. When there is any unprocessed printing description file F1 (Yes in step #24), the controller 20 performs step #21.

When all the printing description files F1 are analyzed (No in step #24), the processor 10 makes the display 12 display the analysis results (step #25). Then, the processor 10 ends the flow chart (END).

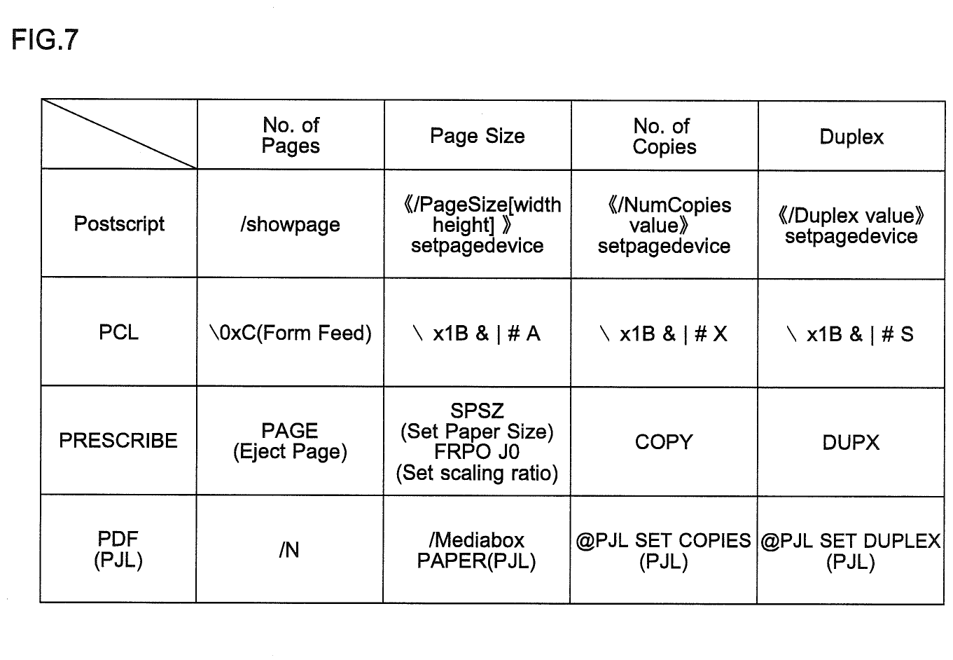

Next, with reference to FIGS. 7 to 9, one example of analysis of the printing description file F1 will be described. FIG. 7 shows one example of commands in the different page description languages. In the table in FIG. 7, the topmost row shows the commands (codes) in Postscript related to the number of pages, the sheet size, the number of print copies, and the printing side of the sheet (simplex or duplex). The second row from the top shows the commands (codes) in PCL related to the number of pages, the sheet size, the number of print copies, and the printing side of the sheet. The third row form the top shows the commands (codes) in PRESCRIBE related to the number of pages, the sheet size, the number of print copies, and the printing side of the sheet. The fourth row from the top shows the commands (codes) in PDF related to the number of pages, the sheet size, the number of print copies, and the printing side of the sheet. In the case of PDF, the sheet size, the number of print copies 64, and the printing side of the sheet are written in the print setting information (PJL data) attached to the PDF file.

Based on the analysis software 18, the processor 10 searches for a description (commands, codes) related to the number of pages, the sheet size, the number of print copies, and the printing side of the sheet. Based on the found description of the number of pages, the sheet size, the number of print copies 64, and the printing side of the sheet, the processor 10 recognizes the number of pages, the sheet size, the number of print copies, and the printing side of the sheet of the printing description file F1.

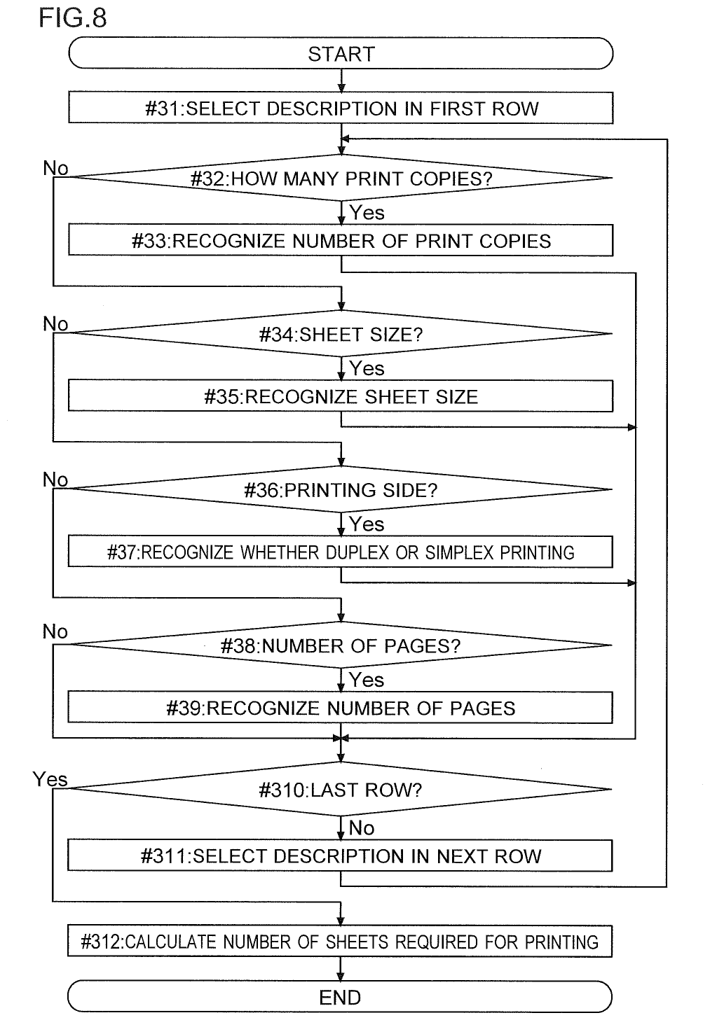

FIG. 8 shows one example of the flow of analyzing the printing description file F1. Regardless of the page description language used in the printing description file F1, the flow of analysis is basically the same. “START” in FIG. 8 is the time point at which analysis of the selected printing description file F1 is started. The processor 10 may analyze, in the printing description file F1, both the part described in the page description language and the print setting information (that is, the entire data).

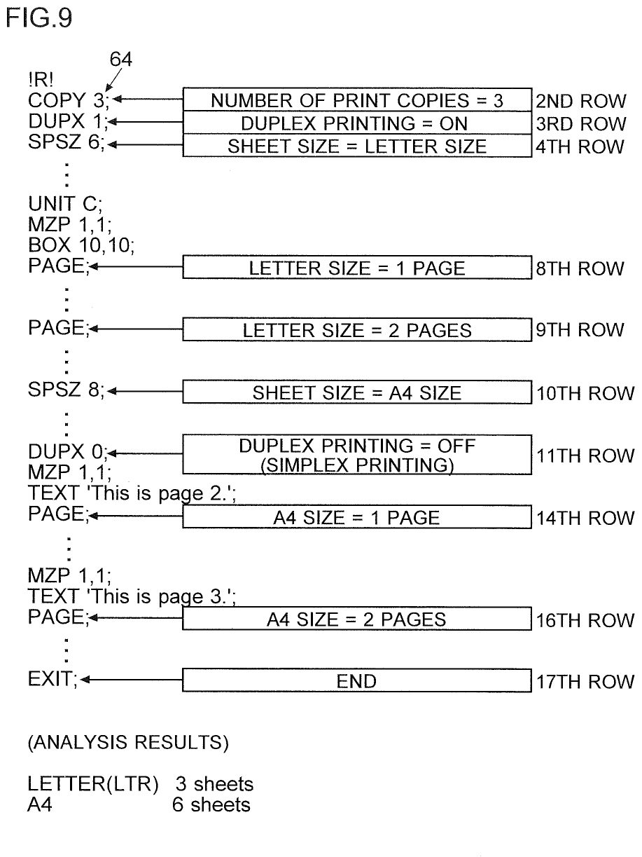

The processor 10 selects the first row (first command) of the printing description file F1 as an analysis target (step #31). Then, the processor 10 checks whether the description in the selected row is related to the number of print copies 64 or not (step #32, see FIG. 9).

When the description is related to the number of print copies 64 (Yes in step #32), based on the description, the processor 10 recognizes the number of print copies 64 (step #33). When the description is not related to the number of print copies 64 (No in step #32), the processor 10 checks whether the description in the selected row is related to the sheet size or not (step #34).

When the description is related to the sheet size (Yes in step #34), based on the description, the processor 10 recognizes the sheet size (step #35). When the description is not related to the sheet size (No in step #34), the processor 10 checks whether the description in the selected row is related to the printing side of the sheet (the description specifying duplex or simplex printing) or not (step #36).

When the description is related to the printing side of the sheet (Yes in step #36), based on the description, the processor 10 recognizes which of duplex or simplex printing is specified (step #37). When the description is not related to the printing side of the sheet (No in step #36), the processor 10 checks whether the description in the selected row is related to the number of pages or not (step #38).

When the description is related to the number of pages (Yes in step #38), based on the description, the processor 10 recognizes the number of pages (step #39). In a language in which a page brake is described at the page boarder, every time the description of a page break is found, the processor 10 adds 1 to the number of pages. In the end, the processor 10 accurately recognizes the total number of pages of the printing description file F1.

When the description is not related to the number of pages (No in step #38), or after step #33, step #35, step #37, or step #39, the processor 10 checks whether the last row in the printing description file F1 has been analyzed or not (step #310). In other words, the processor 10 checks whether the selected printing description file F1 has been completely analyzed or not. For example, when there is a description indicating the end of the file such as “EXIT” or “EOF”, the processor 10 judges that analysis is complete up to the last row.

When there is still any row yet to be analyzed (No in step #310), the processor 10 selects the next row (the next command) to be analyzed as the analysis target (step #311). Then, the processor 10 performs step #32 (returns to step #32). On the other hand, when the printing description file F1 is analyzed up to the last row (Yes in step #310), the processor 10 calculates the number of sheets 65 required for printing the selected printing description file F1 (step #312). Then, the processor 10 ends the flow chart (END).

In the case of a printing description file F1 with simplex printing, the processor 10 calculates the number of sheets 65 by multiplying the number of pages of the recognized printing description file F1 by the number of print copies 64.

In the case of a printing description file F1 with duplex printing, the processor 10 divides the number of page of the recognized printing description file F1 by 2. When it is divisible, the processor 10 calculates the number of sheets 65 by multiplying the value the division yielded by the number of print copies 64. When it is not divisible, the processor 10 calculates the number of sheets 65 by multiplying the sum of the integer part of the value the division yielded and one by the number of print copies 64.

In some printing description files F1, the sheet size used in printing is changed in the course. In this case, the processor 10 calculates the number of sheets 65 for each of the sheet sizes.

In some other printing description files F1, the sheet size for printing is not described (specified). Thus, the input device 13 accepts the setting of a provisional size. On the setting screen 5 shown in FIG. 5, an image like a gear is displayed. This image is a size setting button B2. When the input device 13 accepts operation of the provisional size setting button B2, the processor 10 recognizes the selection screen of the sheet size. The processor 10 takes the sheet size selected on the selection screen as the provisional size. When, as a result of analysis of the printing description file F1, the sheet size used for printing cannot be recognized in the printing description file F1, the processor 10 recognizes that the sheet size used in printing is the provisional size.

For example, suppose that letter size is selected as the provisional size. When the sheet size cannot be recognized, the processor 10 presumes that the sheet size to be used for printing the printing description file F1 is letter size. The processor 10 counts the number of sheets 65 of the printing description file F1, which has been regarded as letter size, in letter size.

With reference to FIG. 9, one example of analysis of descriptions will be described. FIG. 9 shows an excerpt of the descriptions in a printing description file F1 written in PRESCRIBE. In the description shown in FIG. 9, a COPY command is written in the second row (see FIG. 7). Based on this description, the processor 10 recognizes the number following the COPY command as the number of print copies 64. In the case of the printing description file F1 shown in FIG. 9, the processor 10 recognizes the number of print copies 64 as 3.

In the description shown in FIG. 9, a DUPX command is written in the third row. Based on the number following the DUPX command, the processor 10 recognizes whether it is duplex printing or simplex printing. In the case of the printing description file F1 shown in FIG. 9, the processor 10 recognizes that duplex printing is ON.

In the description shown in FIG. 9, a SPSZ command is written in the fourth row. Based on the number following the SPSZ command, the processor 10 recognizes the sheet size. The sheet size corresponding to the number of the SPSZ command is prescribed. In the case of the printing description file F1 shown in FIG. 9, the processor 10 recognizes the size corresponding to 6 (letter size) as the sheet size.

In the description shown in FIG. 9, PAGE commands are written in the eighth and ninth rows. Based on the PAGE commands, the processor 10 counts the number of pages. Since the PAGE command appears twice, the processor 10 regards the count number of pages in letter size as 2.

In the description shown in FIG. 9, a second SPSZ command is written in the tenth row. The second SPSZ command indicates a switch in the used sheet size. Based on the number following the second SPSZ command, the processor 10 recognizes the sheet size. In the case of the printing description file F1 shown in FIG. 9, the processor 10 recognizes A4 size which is prescribed to correspond to 8 as the sheet size.

In the description shown in FIG. 9, a second DUPX command is written in the eleventh row. The command in the eleventh row shows which of duplex and simplex printing is performed for the sheet after the switching. Based on the number following the second DUPX command, the processor 10 recognizes whether it is duplex printing or simplex printing. In the case of the printing description file F1 shown in FIG. 9, the processor 10 recognizes that simplex printing is performed (that is, the duplex printing is OFF) for the second type of sheet size.

In the description shown in FIG. 9, PAGE commands are written in the fourteenth and sixteenth rows. Based on the PAGE commands, the processor 10 counts the number of pages. Since the PAGE command appears twice, the processor 10 regards the count number of pages in A4 size as 2. In the description shown in FIG. 9, based on the description in the seventeenth row, the processor 10 recognizes that all the rows (commands) in the printing description file F1 have been analyzed.

For letter size, duplex printing is performed. Thus, the processor 10 divides the number of pages (two pages) for duplex printing by two. This is because printing of two pages is performed on one sheet. The processor 10 multiplies the number the division yielded by the number of print copies 64 (1×3=3). The processor 10 takes the number the multiplication yielded, namely three, as the number of sheets 65 in letter size. For A4 size, simplex printing is performed. Thus, the processor 10 multiplies the number of pages (two pages) for simplex printing by three (the number of print copies 64) (2×3=6). The processor 10 takes the number the multiplication yielded, namely six, as the number of sheets 65 in A4 size. In the end, the processor 10 takes three for letter size and six for A4 size as the number of sheets 65.

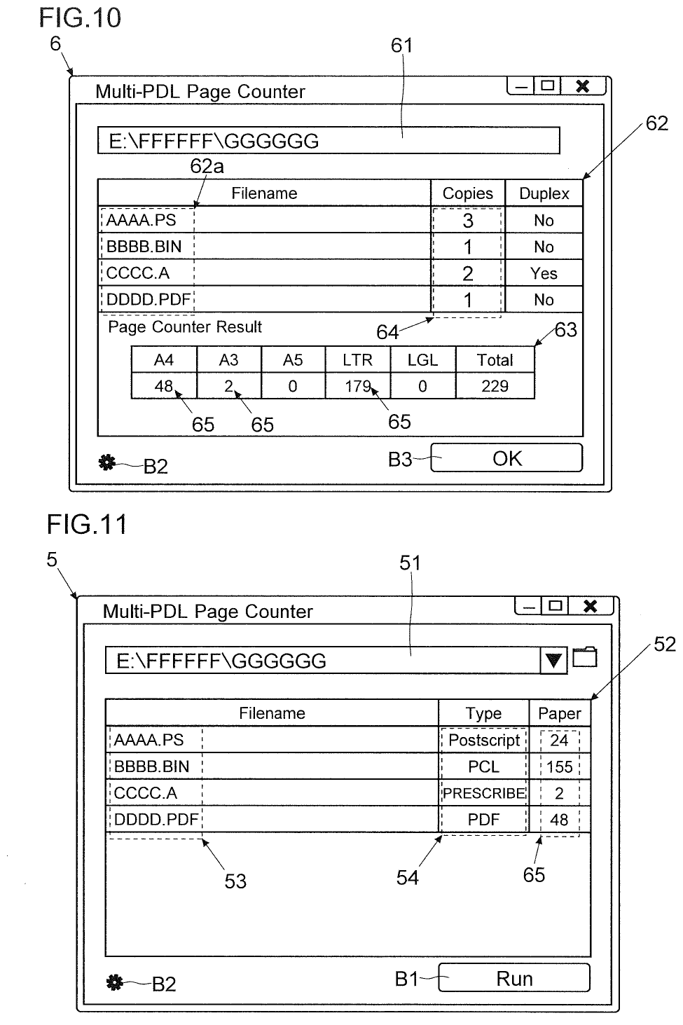

Next, one example of display of the analysis result will be described. When all the printing description files F1 in the storage destination have been analyzed, the processor 10 makes the display 12 display an analysis result screen 6. FIG. 10 shows one example of the analysis result screen 6.

The processor 10 makes an analyzed location display field 61, a file list 62, a sheet quantity table 63, and an OK button B3 displayed on the analysis result screen 6. The analyzed location display field 61 shows the storage location (the storage location specified previously by a user) of the analyzed printing description files F1.

The file list 62 on the analysis result screen 6 is a list of the analysis results of the printing description files F1 stored at the analyzed (specified) storage destination. In the file list 62, one printing description file F1 is allocated to each line. The file name 62a, the number of print copies 64, and whether duplex printing is performed or not is displayed in one line. In this way, the processor 10 makes the display 12 display the number of print copies 64 in printing based on the printing description file F1. The processor 10 makes the display 12 display whether printing based on the printing description file F1 is simplex printing or duplex printing.

The sheet quantity table 63 is a table showing the sum of the required number of sheets 65 when all the printing description files F1 present at the storage destination are printed. The processor 10 makes the sum of the number of sheets 65 displayed for each size. As shown at the far right of the sheet quantity table 63, the processor 10 may make the grand total of the number of sheets 65 for each size displayed. The processor 10 analyzes the printing description file F1 stored at the storage destination. The processor 10 recognizes the number of sheets and the sheet size required for printing each printing description file F1. The processor 10 makes the display 12 display the number of sheets 65 of all the printing description files F1 for each of the recognized sheet sizes.

Checking the number of sheets 63 makes it possible, before printing, to recognize the number of sheets required for printing. It is possible to recognize the number of sheets without opening the printing description file F1 and manually checking the number of pages and the like. Also, checking the sheet quantity table 63 makes it possible to recognize the required type of sheets. In the example in FIG. 10, a user can recognize that three types of sheets are required. In addition, it is easier to estimate the time required for printing all the printing description files F1.

When the OK button B3 on the analysis result screen 6 is operated, the processor 10 makes the display 12 display the setting screen 5 again. FIG. 11 shows one example of the setting screen 5 which is displayed again after the analysis. The processor 10 makes the setting screen 5 reflect the analysis results. The processor 10 includes in the file list 52 the identified number of sheets 65. The processor 10 makes the display 12 display, in a one on the list, the number of sheets 65 required for printing the corresponding printing description file F1.

Thus, according to the embodiment, the information processing apparatus 1 includes the display 12, the input device 13, and the processor 10. The display 12 performs displaying. The input device 13 accepts input operation. When the input device 13 accepts specification of the storage destination, the processor 10 analyzes the printing description file F1 stored at the storage destination. The processor 10 makes the display 12 display the number of sheets 65 required for printing the printing description file F1 (see FIG. 10). The printing description file F1 is data temporarily stored at the storage destination before it is transmitted to the image forming apparatus 2. The printing description file F1 is used in printing by the image forming apparatus 2. The printing description file F1 is data that is generated by converting a file and in which printing content is described using commands.

It is possible to make the information processing apparatus 1 analyze the printing description file F1 which is temporarily stored at a specified storage destination (directory, folder). Based on the analysis results, it is possible to give a notification of the number of sheets required for printing the printing description file F1. It is thus possible to easily check the number of sheets required for printing the printing description file F1. A user does not need to open the printing description file F1 to manually check the number of pages. Manually checking the printing description file F1 requires special knowledge of the grammar of the description language. It is possible to recognize the number of sheets required for printing the printing description file F1 without special knowledge.

The processor 10 analyzes the printing description file F1 to recognize the sheet size which is the size of the sheets used for printing the printing description file F1. The processor 10 makes the display 12 display the recognized sheet size (see FIG. 10). Based on the analysis results, it is possible to notify a user of the sheet size required for printing the printing description file F1. The user does not need to open the printing description file F1 to manually check the sheet size.

The processor 10 analyzes a plurality of printing description files F1 stored at the storage destination. The processor 10 recognizes the number of sheets 65 and the sheet size required for printing for each of the printing description files F1. The processor 10 makes the display 12 display the number of sheets 65 required for printing a plurality of printing description files F1 for each of the recognized sheet sizes (see FIG. 10). It is possible to notify a user of the number of sheets and the sheet size required for printing a plurality of printing description files F1 together. The user does not need to open a plurality of printing description files F1 one by one to manually check the sheet size and the number of sheets 65 one by one.

In some files written in a page description language, the sheet size is not described (defined). In this case, even when the printing description file F1 is analyzed, the information processing apparatus 1 cannot check the sheet size. The input device 13 accepts the setting of the provisional size. When the processor 10 cannot recognize the sheet size of the printing description file F1 even when the printing description file F1 is analyzed, the processor 10 recognizes that the sheet size is the provisional size. This makes it possible to determine the sheet size used in the printing description file F1 when its sheet size is unknown.

The processor 10 recognizes the type 54 of the printing description file F1. The processor 10 makes the display 12 display the type 54 of the recognized printing description file F1. It is possible to notify a user of the type 54 (the type of the used page description language) of the printing description file F1.

When the printing description file F1 is analyzed, the processor 10 makes the display 12 display the number of print copies 64 of the printing description file F1 Based on the analysis results, it is possible to notify a user of the number of print copies 64 of the printing description file F1. The user does not need to open the printing description file F1 to manually check the number of print copies 64.

When the printing description file F1 is analyzed, the processor 10 makes the display 12 display whether printing of the printing description file F1 is simplex or duplex printing (see FIG. 10). Based on the analysis results, it is possible to notify a user whether the printing description file F1 is for duplex printing or simplex printing. The user does not need to open the printing description file F1 to manually check whether it is duplex printing or simplex printing.

The processor 10 converts the file for which the print instruction was entered to generate the printing description file F1. The information processing apparatus 1 can generate the printing description file F1. The generated printing description file F1 can be temporarily stored in the storage medium 11. In other words, the printing description file F1 can be stored instead of being transmitted to the image forming apparatus 2 immediately.

When a plurality of printing description files F1 are analyzed, the processor 10 makes the display 12 display the number of sheets 65 required for printing for each of the printing description files F1 (see FIG. 11). It is possible to notify a user of the number of sheets 65 required for printing each printing description file F1.

The description given above of embodiments of the present disclosure is in no way meant to limit the scope of the present disclosure; the present disclosure can be implemented with any modifications made without departing from the spirit of the present disclosure. The present disclosure is applicable to the information processing apparatuses involving the printing description file.

What is claimed is:

1. An information processing apparatus, comprising:
a display which performs displaying;
an input device which accepts input operation; and
a processor which, when the input device accepts specification of a storage destination, analyzes a printing description file stored at the storage destination to display a number of sheets required for printing the printing description file,
wherein
the printing description file
contains data temporarily stored at the storage destination before being transmitted to an image forming apparatus,
is used in printing by the image forming apparatus, and
contains data which is generated by converting a file and which describes printing content using commands.

2. The information processing apparatus according to claim 1,
wherein
the processor
analyzes the printing description file to recognize a sheet size which is a size of sheets used for printing the printing description file, and
makes the display display the recognized sheet size.

3. The information processing apparatus according to claim 1,
wherein
the processor
analyzes a plurality of printing description files stored at the storage destination,
recognizes the number of sheets and the sheet size required for printing for each of the printing description files, and
makes the display display the number of sheets required for printing the plurality of printing description files for each of the recognized sheet sizes.

4. The information processing apparatus according to claim 2,
wherein
the input device accepts setting of a provisional size, and
when the processor cannot recognize the sheet size of the printing description file even when the printing description file is analyzed, the processor recognizes that the sheet size is the provisional size.

5. The information processing apparatus according to claim 1,
wherein
the processor
recognizes a type of the printing description file, and
makes the display display the type of the recognized printing description file.

6. The information processing apparatus according to claim 1,
wherein
when the printing description file is analyzed,
the processor makes the display display a number of print copies in the printing description file.

7. The information processing apparatus according to claim 1,
wherein
when the printing description file is analyzed,
the processor makes the display display whether printing of the printing description file is simplex printing or duplex printing.

8. The information processing apparatus according to claim 1,
wherein
the processor converts the file for which a print instruction was entered to generate the printing description file.

9. The information processing apparatus according to claim 1,
wherein
when the plurality of printing description files are analyzed,
the processor makes the display display the number of sheets required for printing for each of the printing description files.

10. A method of controlling an information processing apparatus comprising:
upon accepting specification of a storage destination, analyzing a printing description file stored at the storage destination,
displaying a number of sheets required for printing the printing description file based on analysis results,
the printing description file containing data stored temporarily at the storage destination before being transmitted to an image forming apparatus,
using the printing description file in printing by the image forming apparatus, and
the printing description file containing data which is generated by converting a file and which describes printing content using a command.
